(19) United States
(12) Patent Application Publication
(10) Pub. No.: US 2026/0064553 A1
(43) Pub. Date: Mar. 5, 2026

(54) MACHINE LEARNING PERFORMANCE ABSTRACTION

(71) Applicant: Nokia Technologies Oy, Espoo (FI)

(72) Inventors: Stephen MWANJE, Munich (DE); Shu Qiang SUN, Chengdu (CN); Malathi PONNIAH, Bangalore (IN)

(21) Appl. No.: 19/104,487

(22) PCT Filed: Sep. 1, 2022
(86) PCT No.: PCT/CN2022/116524

§ 371 Date: Feb. 18, 2025

(51) Int. Cl. G06F 11/34

(52) U.S. Cl. CPC G06F 11/34

(57) ABSTRACT

of machine learning performance, including: a first device transmits, to a second device, a first abstraction request for at least one performance of a machine learning (ML) entity provided by the first device, the machine learning entity used for a third device. The first device receives, from the second device, a first abstraction report comprising at least one index of the at least one performance, the at least one index being understandable by the third device. In this way, artificial intelligence (AI) or machine learning performance metrics are qualified and abstracted into AI or ML consumer understandable indices.

### FIELD

Various example embodiments of the present disclosure generally relate to the field of telecommunication and in particular, to methods, devices, apparatuses and computer readable storage medium for machine learning (ML) performance abstraction.

### BACKGROUND

Cognitive Autonomous Networks (CAN) aim to provide intelligence and autonomy in network Operations, Administration and Management (OAM) as well as in the network procedures to support the increased flexibility and complexity of the radio network. In order to achieve the Cognitive Functions in the CAN Network, ML and Artificial Intelligence (AI) technologies play a key role. An ML-enabled network or management function provides ML-based management services (MnS), for example, training or inference MnS, to an AI/ML MnS consumer.

The MnS consumer may be interested in performances of the ML application (e.g., ML App) contained in the ML-enabled function. Moreover, the MnS consumer may also wish to know performance achievements of the AI/ML applications as measured on different performance metrics for, e.g., accuracy, trustworthiness, speed, resource consumption, etc.

### SUMMARY

In a first aspect of the present disclosure, there is provided a first device. The first device comprises at least one processor; and at least one memory storing instructions that, when executed by the at least one processor, cause the first device at least to: transmit, to a second device, a first abstraction request for at least one performance of a machine learning entity provided by the first device, the machine learning entity used for a third device; and receive, from the second device, a first abstraction report comprising at least one index of the at least one performance, the at least one index being understandable by the third device.

In a second aspect of the present disclosure, there is provided a second device. The second device comprises at least one processor; and at least one memory storing instructions that, when executed by the at least one processor, cause the second device at least to: receive, from one of a first device or a third device, an abstraction request for at least one performance of a machine learning entity provided by the first device, the machine learning entity used for the third device; determine at least one index of the at least one performance, the at least one index being understandable by the third device; and transmit, to a corresponding one of the first device or the third device, an abstraction report comprising the at least one index of the at least one performance.

In a third aspect of the present disclosure, there is provided a third device. The third device comprises at least one processor; and at least one memory storing instructions that, when executed by the at least one processor, cause the third device at least to: transmit, to one of a first device or a second device, an abstraction request for at least one performance of a machine learning entity provided by the first device, the machine learning entity used for the third device; and receive, from a corresponding one of the first device or the second device, an abstraction report comprising the at least one index of the at least one performance, the at least one index being understandable by the third device.

In a fourth aspect of the present disclosure, there is provided a method. The method comprises: transmitting, at a first device and to a second device, a first abstraction request for at least one performance of a machine learning entity provided by the first device, the machine learning entity used for a third device; and receiving, from the second device, a first abstraction report comprising at least one index of the at least one performance, the at least one index being understandable by the third device.

In a fifth aspect of the present disclosure, there is provided a method. The method comprises: receiving, at a second device and from one of a first device or a third device, an abstraction request for at least one performance of a machine learning entity provided by the first device, the machine learning entity used for the third device; determining at least one index of the at least one performance, the at least one index being understandable by the third device; and transmitting, to a corresponding one of the first device or the third device, an abstraction report comprising the at least one index of the at least one performance.

In a sixth aspect of the present disclosure, there is provided a method. The method comprises: transmitting, at a third device and to one of a first device or a second device, an abstraction request for at least one performance of a machine learning entity provided by the first device, the machine learning entity used for the third device; and receiving, from a corresponding one of the first device or the second device, an abstraction report comprising the at least one index of the at least one performance, the at least one index being understandable by the third device.

In a seventh aspect of the present disclosure, there is provided a first apparatus. The first apparatus comprises: means for transmitting, to a second apparatus, a first abstraction request for at least one performance of a machine learning entity provided by the first apparatus, the machine learning entity used for a third apparatus; and means for receiving, from the second apparatus, a first abstraction report comprising at least one index of the at least one performance, the at least one index being understandable by the third apparatus.

In an eighth aspect of the present disclosure, there is provided a second apparatus. The second apparatus comprises: means for receiving, from one of a first apparatus or a third apparatus, an abstraction request for at least one performance of a machine learning entity provided by the first apparatus, the machine learning entity used for the third apparatus; means for determining at least one index of the at least one performance, the at least one index being understandable by the third apparatus; and means for transmitting, to a corresponding one of the first apparatus or the third apparatus, an abstraction report comprising the at least one index of the at least one performance.

In a ninth aspect of the present disclosure, there is provided a third apparatus. The third apparatus comprises: means for transmitting, to one of a first apparatus or a second apparatus, an abstraction request for at least one performance of a machine learning entity provided by the first apparatus, the machine learning entity used for the third apparatus; and means for receiving, from a corresponding one of the first apparatus or the second apparatus, an abstraction report comprising the at least one index of the at least one performance, the at least one index being understandable by the third apparatus.

In a tenth aspect of the present disclosure, there is provided a computer readable medium. The computer readable medium comprises instructions stored thereon for causing an apparatus to perform at least the method according to the fourth aspect.

In an eleventh aspect of the present disclosure, there is provided a computer readable medium. The computer readable medium comprises instructions stored thereon for causing an apparatus to perform at least the method according to the fifth aspect.

In a twelfth aspect of the present disclosure, there is provided a computer readable medium. The computer readable medium comprises instructions stored thereon for causing an apparatus to perform at least the method according to the sixth aspect.

It is to be understood that the Summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some example embodiments will now be described with reference to the accompanying drawings, where:

FIG. 1 illustrates an example communication environment in which example embodiments of the present disclosure can be implemented;

FIG. 2 illustrates a signaling chart for communication according to some example embodiments of the present disclosure;

FIG. 3 illustrates a signaling chart for communication according to some example embodiments of the present disclosure;

FIG. 4 illustrates an example of an information model for ML performance abstraction control according to some example embodiments of the present disclosure;

FIG. 5 illustrates a schematic diagram of ML performance abstraction inheritance relations according to some example embodiments of the present disclosure;

FIG. 6 illustrates a flowchart of a method implemented at a first device according to some example embodiments of the present disclosure;

FIG. 7 illustrates a flowchart of a method implemented at a second device according to some example embodiments of the present disclosure;

FIG. 8 illustrates a flowchart of a method implemented at a third device according to some example embodiments of the present disclosure;

FIG. 9 illustrates a simplified block diagram of a device that is suitable for implementing example embodiments of the present disclosure; and

FIG. 10 illustrates a block diagram of an example computer readable medium in accordance with some example embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. Embodiments described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first,” “second” and the like may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

As used herein, unless stated explicitly, performing a step “in response to A” does not indicate that the step is performed immediately after “A” occurs and one or more intervening steps may be included.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “communication network” refers to a network following any suitable communication standards, such as New Radio (NR), Long Term Evolution (LTE), LTE-Advanced (LTE-A), Wideband Code Division Multiple Access (WCDMA), High-Speed Packet Access (HSPA), Narrow Band Internet of Things (NB-IoT) and so on. Furthermore, the communications between a terminal device and a network device in the communication network may be performed according to any suitable generation communication protocols, including, but not limited to, the first generation (1G), the second generation (2G), 2.5G, 2.75G, the third generation (3G), the fourth generation (4G), 4.5G, the fifth generation (5G) communication protocols, and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “network device” refers to a node in a communication network via which a terminal device accesses the network and receives services therefrom.

The network device may refer to a base station (BS) or an access point (AP), for example, a node B (NodeB or NB), an evolved NodeB (eNodeB or eNB), an NR NB (also referred to as a gNB), a Remote Radio Unit (RRU), a radio header (RH), a remote radio head (RRH), a relay, an Integrated Access and Backhaul (IAB) node, a low power node such as a femto, a pico, a non-terrestrial network (NTN) or non-ground network device such as a satellite network device, a low earth orbit (LEO) satellite and a geosynchronous earth orbit (GEO) satellite, an aircraft network device, and so forth, depending on the applied terminology and technology. In some example embodiments, radio access network (RAN) split architecture comprises a Centralized Unit (CU) and a Distributed Unit (DU) at an IAB donor node. An IAB node comprises a Mobile Terminal (IAB-MT) part that behaves like a UE toward the parent node, and a DU part of an IAB node behaves like a base station toward the next-hop IAB node.

The term “terminal device” refers to any end device that may be capable of wireless communication. By way of example rather than limitation, a terminal device may also be referred to as a communication device, user equipment (UE), a Subscriber Station (SS), a Portable Subscriber Station, a Mobile Station (MS), or an Access Terminal (AT). The terminal device may include, but not limited to, a mobile phone, a cellular phone, a smart phone, voice over IP (VOIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. The terminal device may also correspond to a Mobile Termination (MT) part of an IAB node (e.g., a relay node). In the following description, the terms “terminal device”, “communication device”, “terminal”, “user equipment” and “UE” may be used interchangeably.

As used herein, the term “resource,” “transmission resource,” “resource block,” “physical resource block” (PRB), “uplink resource,” or “downlink resource” may refer to any resource for performing a communication, for example, a communication between a terminal device and a network device, such as a resource in time domain, a resource in frequency domain, a resource in space domain, a resource in code domain, or any other resource enabling a communication, and the like. In the following, unless explicitly stated, a resource in both frequency domain and time domain will be used as an example of a transmission resource for describing some example embodiments of the present disclosure. It is noted that example embodiments of the present disclosure are equally applicable to other resources in other domains.

As used herein, the term “model” is referred to as an association between an input and an output learned from training data, and thus a corresponding output may be generated for a given input after the training. The generation of the model may be based on a machine learning (ML) technique. The machine learning techniques may also be referred to as artificial intelligence (AI) techniques. In general, a machine learning model can be built, which receives input information and makes predictions based on the input information. For example, a classification model may predict a category of input information among a predetermined number of categories. As used herein, “model” may also be referred to as “machine learning model”, “learning model”, “machine learning network”, or “learning network,” which are used interchangeably herein.

Hereinafter, the AI/ML MnS consumer may be simply referred to as the MnS consumer, the AI/ML consumer, or the ML consumer. An AI/ML MnS producer that contains an AI/ML-based function or AI/ML service instance may be simply referred to as the MnS producer, the AI/ML producer or the ML producer.

As previously discussed, the AI/ML consumer may be interested in understanding the performance of a given AI/ML service instance. However, the AI/ML consumer may not always be able to interpret various metrics on performance key performance indicators (KPIs), such as, accuracy, confidence, etc. Therefore, there is a need to provide means to abstract the measured metrics and qualify into indices that can be easily interpreted by any consumer of AI/ML-related performance management even without a deep knowledge of the specific AI/ML metrics.

### Example Environment

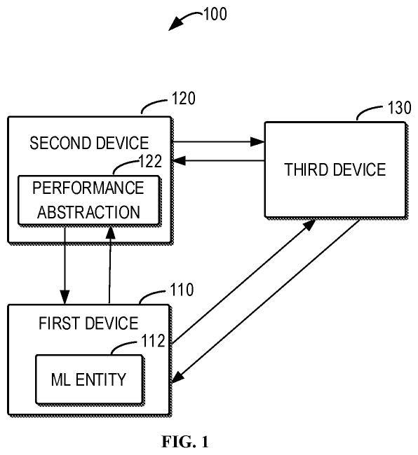

FIG. 1 illustrates an example communication environment 100 in which example embodiments of the present disclosure can be implemented. The communication environment 100 may be a management system in which a plurality of entities or devices are involved, including a first device 110, a second device 120, and a third device 130.

As shown in FIG. 1, the first device 110, the second device 120, and the third device 130 may communicate with each other. The first device 110 serves as a producer of management services or tasks, which may be implemented by a ML entity 112. The management services or tasks may be, for example, AI/ML training or inference services, or any other AI/ML services. Hereinafter, the first device 110 is also referred to as a MnS producer 110, or an AI/ML MnS producer 110.

The ML entity 112 may be an AI/ML model or contain the AI/ML model or AI/ML enabled function that may be managed as a single composite entity. The AI/ML training may refer to a capability and associated end-to-end processes to enable an AI/ML Training Function to train its constituent AI/ML model, e.g., to interact with external parties to collect and format the data required for training the AI/ML model. The AI/ML model may be a mathematical function or an artefact that contains a mathematical function and meta data about the mathematical function. In the example embodiments, the term “AI/ML entity” may be referred to any of this variation of artefacts capable of making predictions using AI/ML logic.

The AI/ML-enabled function may be any network-related function that applies AI/ML to accomplish an objective of the network-related function. The AI/ML-enabled function may contain one or several AI/ML entities. Examples of network-related functions may include:
management functions, such as, Management data analytics function or Self-organizing network functions;
Core network functions for analytics, such as, the network data analytics function (NWDAF) or core network functions for decision making like the Access and Mobility Management Function (AMF);
RAN network functions e.g., a RAN network function in the gNB for automation like DSON functions, or for call processing like media access control functions.

In some example embodiments, the AI/ML model or AI/ML enabled function of ML entity 112 may have at least one performance, including but not limited to a precision, a recall, a F1-score, an accuracy, mean absolute error, root mean squared error, trustworthiness, resource consumption, speed and so on. Such a performance may be characterized by a corresponding performance metric. In some cases, the third device 130 may not be able to interpret the performance metric.

The third device 130 may be a consumer of the management services provided by the first device 110. Hereinafter, the third device 130 is also referred to a MnS consumer 130, or an AI/ML MnS consumer 130. The AI/ML MnS consumer may be a network operator or another management function of a 5G system (5GS) that has interest in the AI/ML entities contained within or the AI/ML capabilities supported by AI/ML-enabled function. In some example embodiments, the third device 130 may expect to have qualified and abstracted performance of the ML entity 112.

The second device 120 is used for realizing performance abstraction function. In some example embodiments, the second device 120 may serve as an external entity for the first device 110 and the third device 130. Hereinafter, the second device 120 is also referred to as a producer of ML performance abstraction 120 or a ML performance abstraction MnS producer 120.

In some example embodiments, the performance abstraction function may be implemented by an information model for performance abstraction 122, which is also referred to as the information model 122 or the performance abstraction model 122 hereinafter. In particular, the second device 120 may obtain raw metrics of at least one performance of the ML entity 112 (e.g., metric values), which is an input of the performance abstraction model 122. The performance abstraction model 122 may derive and output corresponding performance indices based on the metric values. Such performance indices are understandable by the third device 130, which will be described in detail below.

Note that although illustrated as separate devices, two or more of the first device 110, the second device 120 and the third device 130 may be run at least partly in the same cloud infrastructure. It is to be understood that the number of devices and their connections shown in FIG. 1 are only for the purpose of illustration without suggesting any limitation. The management network 100 may include any suitable number of devices configured to implementing example embodiments of the present disclosure. Although not shown, it would be appreciated that one or more additional devices may be located in the management network 100.

Communications in the communication environment 100 may be implemented according to any proper communication protocol(s), comprising, but not limited to, cellular communication protocols of the first generation (1G), the second generation (2G), the third generation (3G), the fourth generation (4G), the fifth generation (5G), the sixth generation (6G), and the like, wireless local network communication protocols such as Institute for Electrical and Electronics Engineers (IEEE) 802.11 and the like, and/or any other protocols currently known or to be developed in the future. Moreover, the communication may utilize any proper wireless communication technology, comprising but not limited to: Code Division Multiple Access (CDMA), Frequency Division Multiple Access (FDMA), Time Division Multiple Access (TDMA), Frequency Division Duplex (FDD), Time Division Duplex (TDD), Multiple-Input Multiple-Output (MIMO), Orthogonal Frequency Division Multiple (OFDM), Discrete Fourier Transform spread OFDM (DFT-s-OFDM) and/or any other technologies currently known or to be developed in the future.

### Work Principle and Example Signaling for Communication

According to some example embodiments of the present disclosure, there is provided a solution for abstraction of ML performance. In this solution, a second device is provided to support ML performance abstraction. In particular, the second device receives an abstraction request for at least one performance of ML entity provided by a first device. The ML entity is used for a third device. The second device determines at least one index of the at least one performance that is understandable by the third device. The second device transmits an abstraction report comprising the at least one index of the at least one performance. In this way, the AI/ML performance can be qualified and abstracted into indices understandable by a consumer of the AI/ML service instance. Therefore, the communication between a producer and a consumer of the AI/ML service instance can be improved.

Example embodiments of the present disclosure will be described in detail below with reference to the accompanying drawings.

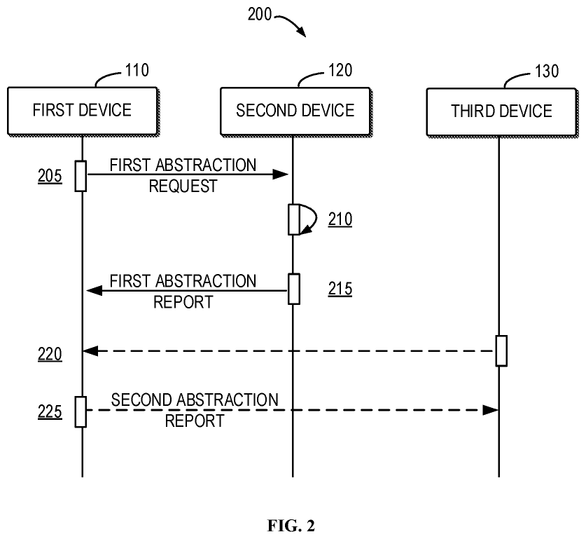

Reference is now made to FIG. 2, which shows a signaling chart 200 for communication according to some example embodiments of the present disclosure. As shown in FIG. 2, the signaling chart 200 involves the first device 110, the second device 120, and the third device 130. For the purpose of discussion, reference is made to FIG. 1 to describe the signaling flow 200. Although one first device 110 and one third device 130 are illustrated in FIG. 2, it would be appreciated that there may be a plurality of first device performing similar operations as described with respect to the first device 110 below and a plurality of third device performing similar operations as described with respect to the third device 130 below.

In the process 200, the first device 110 provides at least one AI/ML entity, e.g., the ML entity 112, that accomplishes a given AI/ML-related task, such as training or inference for at least one AI/ML application contained in that entity. In this case, the ML entity 112 is used for the third device 130. It should be understood that any AI/ML-related task or function other than training or inference is also possible for implementations of the example embodiments.

The first device 110 transmits 205 a first abstraction request (e.g., denoted by MLPerfQualRequest) for at least one performance of the ML entity 112 to the second device 120. The second device 120 is used for realizing ML performance abstraction function, which is denoted by MLPerformanceAbstraction hereinafter. Additionally, the performance may be characterized by a corresponding performance metric, which is denoted by mlPerformanceMetrics.

In some example embodiments, the first abstraction request may be transmitted to initiate qualification and abstraction of at least one performance metric of the AI/ML entity. By way of example, AI/ML performance may include, but not limited to, a precision, a recall, a F1-score, an accuracy, mean absolute error, root mean squared error, trustworthiness, resource consumption, speed of the ML entity 112.

The first abstraction request may indicate the ML entity 112 for which performance abstraction is required. In some example embodiments, the first abstraction request may include an identifier of the ML entity 112 and raw metrics for at least one performance. By way of example, the raw metrics may include, but not limited to, confusion matrix, precision and recall, F1-score, AU-ROC and so on. Additionally, in some example embodiments, the first abstraction request may further include an input and an expected output of the ML entity 112 for which performance abstraction is required.

The second device 120 determines 210 at least one index of the at least one performance that is understandable by the third device 130. Such an index may be denoted by mlPerformanceIndex hereinafter.

In some example embodiments, the performance abstraction model 122 may perform qualification and abstraction of AI/ML performance of the AI/ML-enabled function or ML application contained in the ML entity 112. For example, the performance abstraction model 122 may derive the corresponding performance index from the received metrics values.

The performance index may express an achieved performance of the ML entity 112 on a specific performance metrics as a number on a predetermined grade or a ML performance index range, which is denoted by mlPerformanceIndexRange. The ML performance index range may be predetermined at the first device 110, the second device 120 and the third device 130.

In some example embodiments, an absolute minimum and maximum performances may be specified in advance. For example, a grade of 11 values, such as from a range of 0 to 10, may be used where the lowest value “0” indicates the worst possible performance, and the largest value “10” indicates the best possible performance. In some case, a value “5” may indicate a result similar to a pure random guess, which may indicate the higher the more confident.

For each performance metric, the second device 120 may map a specific performance metric value to the predefined mlPerformanceIndexRange to generate the specific mlAbstractPerfIndex value for that performance metric value. This may then be communicated to the consumers, e.g., the first device 110 and the third device 130.

In some example embodiments, the mlPerformanceIndex may be computed based on only one performance metric. Additionally, or alternatively, in some other example embodiments, an aggregate index may also be derived for a combination of multiple performance metrics, to generate a specific mlAggregatePerfIndex value.

For each abstraction request, the second device 120 may generate an abstraction report comprising the corresponding performance index of the required performance, which is denoted by MLAbstractPerfReport. The second device 120 then transmits 215 a first abstraction report comprising the performance index of the ML performance.

In some example embodiments, the first abstraction request may be submitted directly to the ML entity 112 that undertakes the AI/ML inference. In this case, the ML entity 112 may have undergone the performance abstraction process. In this way, the first device 110 can provide the outcomes of the performance abstraction process by itself.

Additionally, in some example embodiments, the third device 130 may transmit 220 a second abstraction request for the ML performance of the ML entity 112. The second abstraction request may include an indication of the ML entity 112 and at least one metric for the ML performance. By way of example, the indication of the ML entity 112 may be at least one of the following: a name of ML entity 112, an identity (ID) of ML entity 112, a domain name (DN) of ML entity 112. For each of AI/ML-enabled functions or ML Apps, corresponding metrics may be indicated by names, IDs, DNs of the performance metrics.

In some example embodiments, the second abstraction request may be transmitted before the transmission of the first abstraction request. In this case, the transmission of the second abstraction request causes the first abstraction request to be transmitted from the first device 110 to the second device 120. Alternatively, in some other example embodiments, the second abstraction request may be transmitted after the transmission of the first abstraction request.

In response to the second abstraction request, the first device 110 may transmit 225 a second abstraction report comprising the performance index of the performance metrics.

In some example embodiments, the third device 130 may request the second device 120 to filter and provide the abstraction report of at least one ML-enabled function or ML App that is satisfying certain filtering criteria. By way of example, the filtering criteria may be that a prediction accuracy is more than 95% or any other criteria like prediction accuracy etc.

In some example embodiments, the second device 120 may then publish the performance abstraction Result, i.e., the performance indices on an authorized portal.

According to the example embodiments, ML performance abstraction is enabled in a communication network or a management system. Various performance metrics of a plurality of ML Apps or AI/ML enabled functions can be qualified and abstracted in a standardized format, i.e., performance indices that are understandable by consumers of ML Apps or AI/ML enabled functions.

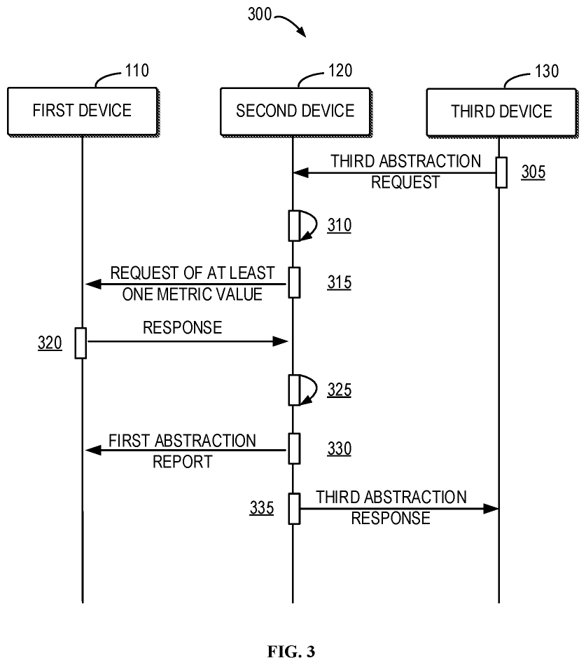

FIG. 3 illustrates a signaling chart 300 for communication according to some example embodiments of the present disclosure. As shown in FIG. 3, the signaling chart 300 involves the first device 110, the second device 120, and the third device 130. For the purpose of discussion, reference is made to FIG. 1 to describe the signaling flow 200. Although one first device 110 and one third device 130 are illustrated in FIG. 3, it would be appreciated that there may be a plurality of first device performing similar operations as described with respect to the first device 110 below and a plurality of third device performing similar operations as described with respect to the third device 130 below.

Instead of requesting the MnS producer, in process 300, the MnS consumer requests the ML performance abstraction MnS producer for abstract performances. The third device 130 transmits 305 a third abstraction request for at least one performance of the ML entity 112 provided by the first device 110. In some example embodiments, the third abstraction request may comprise an indication of the ML entity 112 and the performance metric for the ML performance.

In some example embodiments, the second device 120 may receive requests for abstract performance of an MLApp or ML-enabled network functions (e.g., the first or third abstraction request) by using MLPerformanceAbstraction Provisioning Management service implemented via CRUD (Create, Read, Update, Delete) operations on MLAbstractPerfRequest objects.

The first abstraction request in the process 200 or the third abstraction request in process 300 may state the following:
mLFunctionID: the request, when transmitted to the MLPerformanceAbstraction, may indicate the identifier of the specific ML-enabled network function for which the consumer wishes to have the abstract performance. However, this may not be necessary when sent to the ML-enabled network function itself.
MLAppID: The request may optionally state the identifier of the specific MLApp for which the consumer wishes to have performance qualified and abstracted.
mlPerformanceMetrics: The request may indicate ML-related performance metrics and their values that shall be evaluated by the MLPerformanceAbstraction for generating the abstract performance index.

The second device 120 determines 310 whether the requested ML performance is known. If the abstraction performance is unknow, the second device 120 may transmit 315 to the first device 110 a request for at least one metric value for the ML performance. Accordingly, in response to the request, the second device 120 may transmit 320 a response comprising at least one metric value for the M; performance.

The second device 120 then determines 325 the performance index corresponding to the at least one metric values. In a case where the ML performance is known, the second device 120 may directly determine the corresponding performance index without requesting the first device 110.

In some example embodiments, the second device 120 may compute the mlPerformanceIndex as the abstraction of the performance metric values as fitted to a predetermined mlPerformanceIndexRange.

Additionally, or alternatively, in some example embodiments, the second device 120 may interact with other ML performance abstraction MnS producer in evaluating raw metrics to the easily understandable performance index.

The second device 120 then transmits 330 a first abstraction report comprising the performance index of the ML performance to the first device 110. Additionally, or alternatively, the second device 120 transmits 335 a third abstraction report comprising the performance index of the ML performance to the third device 130. For the computed mlPerformanceIndex, the information model 122 may compile the MLAbstractPerfReport containing the computed mlPerformanceIndex and forward MLAbstractPerfReport to the consumer, i.e., the function that requests for the performance abstraction, to notify the consumer about the outcomes of the performance abstraction.

In some example embodiments, after reporting the performance index, the second device 120 may further publish the abstract performance to some shared publication spaces.

It should be understood that some of the steps in process 200 or 300 are optional or can be omitted, and the order of the steps is given for an illustrative purpose. For example, step 330 may be performed after step 335, or steps 330 may be performed in parallel with step 335. Thus, the embodiments of the present disclosure are not limited in this regard.

According to the example embodiments of the present disclosure, the AI/ML performance abstraction process is enabled between the MnS producer and consumer. The ML performance abstraction processes can be performed either at deployment, or after (re) training. Moreover, network and automation functions are allowed to interact with ML performance abstraction functions or the AI/ML functions to determine the abstract performance of ML instances.

### Example Computing of ML Abstraction Performance

The performance abstraction entity 122 may apply a plurality of mechanisms to derive ML abstract performances, i.e., translating performance metrics to corresponding indices that are understandable by the MnS consumer. Due to different kinds of performance metrics with various interpretations, different derivation mechanisms for computing the abstraction performances may be needed. Table 1 shows example mechanisms for computing ML abstraction performances.

It should be understood that the performance metrics, the computation and translation in table 1 are given for an illustrative purpose without suggesting any limitation as to the scope of the present disclosure, and any other performance metrics, and corresponding computation and translation are also suitable for implementations of the example embodiments.

TABLE 1
Example mechanisms for computing ML abstraction performance

| Metric | Description | Computation | Translation on range [0-100] |
|---|---|---|---|
| Precision, P | the ratio of true positives (TP) and | $P = \frac{T P}{T P + F P}$ | mlAbstractPerfIndex = P * 100 |
| | total positives | | |
| | predicted; total | | |
| | positives, being the | | |
| | sum of True positives | | |
| | (TP) and False | | |
| | positives (FP) | | |
| F1-score, F1 | The harmonic mean of precision and recall, recall being the true positives to all | $F 1 = \frac{2}{\frac{1}{precision} + \frac{1}{recall}}$ | mlAbstractPerfIndex = F1 * 100 |
| | the positives | | |
| Root Mean squared error, e | the root average of the squared difference between the target value yᵢ yi and the | ${e}^{2} = \frac{1}{N} {\sum }_{j = 1}^{N} {( {y}_{i} - \hat{{y}_{i}} )}^{2}$ | $mlAbstractPerfIndex = 100 [ \frac{1}{1 + \frac{e}{y}} ] ; where \overline{y} is the mean of the samples {y}_{i}$ |
| | predicted value ŷᵢ | | |

### Example Information Model of ML Abstraction Performance

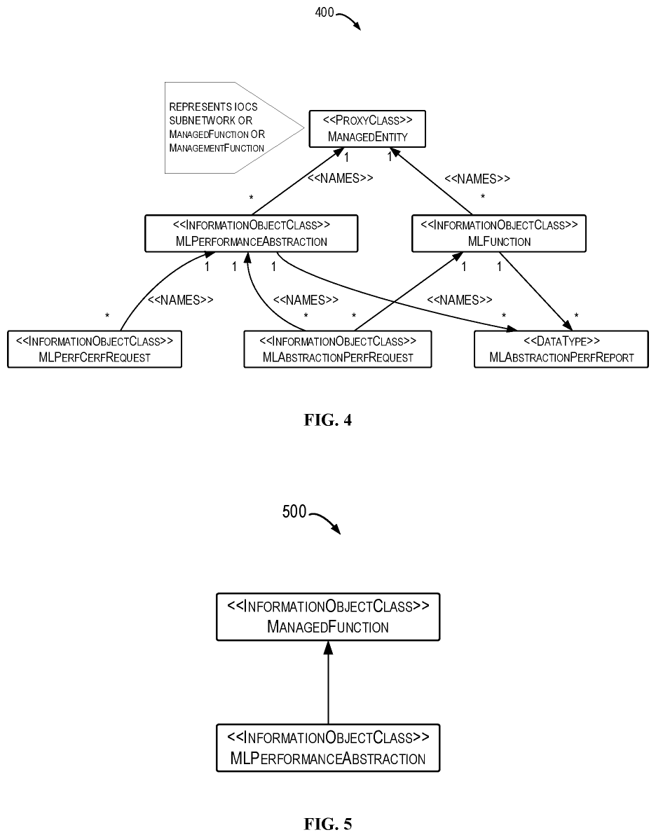

Information object classes (IOCs) and data types needed to realize ML performance abstraction as well as the relationships among these IOCs and data Types will be discussed in the following descriptions. FIG. 4 illustrates an example of an information model 400 for MIL performance abstraction control according to some example embodiments of the present disclosure. FIG. 5 illustrates a schematic diagram of ML performance abstraction inheritance relations 500 according to some example embodiments of the present disclosure.

As shown in FIG. 4, the IOC “MLPerformanceAbstraction” may represent the properties of MLPerformanceAbstraction. MLPerformanceAbstraction is a managed function instantiable from the MLPerformanceAbstraction information object class and name-contained in either a Subnetwork, a ManagedFunction or a ManagementFunction. The MLPerformanceAbstraction is a type of managedFunction. That is, the MLPerformanceAbstraction is a subclass of and inherits the capabilities of a managedFunction.

The MLPerformanceAbstraction has the capability of compiling and delivering reports and notifications about MLPerformanceAbstraction or its associated MLPerfQualRequests, or the MLPerformanceAbstraction itself.
The MLPerformanceAbstraction shall be associated with one or more MLAbstractPerfReports.
Each MLPerformanceAbstraction may have attributes specifying the MLPerformanceAbstraction Reporting characteristics (e.g., periodically, after completion, etc.).
The MLPerformanceAbstraction MnS Producer may also interact with other MLPerformanceAbstraction MnS Producer(s) to when evaluating the input/output or the RAW metrics to the easily understandable index.
The MLPerformanceAbstraction MnS has an information model used to compute and for interaction related to abstract performance values. All received metric values are mapped onto the defined fixed mlPerformanceIndexRange. For example, a range of [0, 10] may be used, all abstract performance values shall be in the range, where 0 indicates a lowest/worst possible performance, while 10 indicates a best possible performance.

The MLPerformanceAbstraction may be associated with at least one MLApps. For example, the MLApps associated with MLPerformanceAbstraction may be associated via a list of MLAppIdentifers.

The MLPerformanceAbstraction may contain at least one MLPerfQualRequests.

Table 2 shows example attributes of the MLPerformanceAbstraction IOC:

TABLE 2
Example attributes of MLPerformanceAbstraction

| | Support | | | | |
|---|---|---|---|---|---|
| Attribute name | Qualifier | isReadable | isWritable | isInvariant | isNotifyable |
| mlPerformanceIndexRange | M | T | T | F | T |
| Attributes related to Role | | | | | |
| MLPerfQualRequestRef | M | T | T | F | T |
| MLAbstractPerfReportRef | M | T | T | F | T |

In some example embodiments, the IOC “MLPerfQualRequest” may represent the properties of MLPerfQualRequest. For each request to abstract and qualify the performance of the a given MLApp, a consumer may create a new MLPerfQualRequest on the MLPerformanceAbstraction, i.e., MLPerfQualRequest shall be an information object class that is instantiated for each request to abstract and qualify performance.
Each MLPerfQualRequest identifies at least one MLApp (e.g., using the MLAppID) that has generated the performance for which performance abstraction is requested.
The MLPerfQualRequest may indicate the source function (e.g., as a sourceFunctionID) to identify where the request is coming from. This may for example be the DN of the source function.
The sourceFunctionID and the MLAppID are needed so that the MLPerformanceAbstraction can relate the derived abstract performance with the respective function and so that it can report in subsequent abstract performance requests the appropriate abstract performance of each respective function.
Each MLPerfQualRequest must include the performance metrics and values to be evaluated and translated into an abstract performance.

Table 3 shows example attributes of the IOC “MLPerfQualRequest”.

TABLE 3
Example attributes of MLPerfQualRequest

| | Support | | | | |
|---|---|---|---|---|---|
| Attribute name | Qualifier | isReadable | isWritable | isInvariant | isNotifyable |
| MLPerfQualRequest ID | M | T | F | F | F |
| MLAppID | O | T | F | F | F |
| sourceFunctionID | O | T | T | F | T |
| mlPerformanceMetrics | M | T | T | F | T |

In some example embodiments, the IOC “MLPerfQualRequest” may represent the properties of MLAbsractPerfRequest. Abstract Performance can be requested from either the AI/ML function itself (i.e., the function that hosts the ML App) or from the MLPerformanceAbstraction function.

For each request for abstract performance, a consumer may create a new MLAbstractPerfRequest on either the MLPerformanceAbstraction, or on the ML function i.e., MLAbstractPerfRequest is an information object class that is instantiated for each request for abstract Performance.
Each MLAbstractPerfRequest identifies at least one MLApp (e.g., using the MLAppID) whose abstract performance is required.
The MLAbstractPerfRequest towards the MLPerformanceAbstraction may identify a function (e.g., using the MLFunctionID) whose abstract performance is required.
The MLAbstractPerfRequest may indicate the name(s) of one or more performance metrics for which abstract performance is required. If this is the case, the report may indicate the result on only those stated performance metrics names.

Table 4 shows example attributes of the IOC “MLAbstractPerfRequest”.

TABLE 4
Example attributes of MLAbstractPerfRequest

| | Support | | | | |
|---|---|---|---|---|---|
| Attribute name | Qualifier | isReadable | isWritable | isInvariant | isNotifyable |
| MLAbstractPerfRequestID | M | T | F | F | F |
| MLAppID | O | T | F | F | F |
| MLFunctionID | O | T | T | F | T |
| mlPerformanceMetricName | M | T | T | F | T |

In some example embodiments, the data type “MLAbsractPerfReport” may represent the properties of MLAbstractPerfReport. The MLPerformanceAbstraction may generate one or more MLAbsractPerfReport, and each MLAbsractPerfReport may be associated to one or more MLApps. MLPerformanceAbstraction may provide report about MLAbstractPerfRequests on the given one or more MLApps. Correspondingly, the MLAbsractPerfReport is associated with an instance of MLAbstractPerfRequest.

The MLAbsractPerfReport may provide abstract performance for each performance metrics included in the request as well as for the complete set of performance metrics. By way of example, if performance metrics are stated in the request for abstract performance, the MLPerformanceAbstraction may be implemented such that abstract performance is reported only for those performance metrics for each metrics that are included in the MLAbstractPerfRequest. Otherwise, if the request for abstract performance only indicates the MLFunction, the MLPerformanceAbstraction may be implemented such that abstract performance is reported for all performance metrics supported by the MLFunction as well as for the aggregate abstract performance. In principle, at least one of them must report, so both mlAggregatePerfIndex and abstractPerfIndices are conditional mandatory (CM).

Table 5 shows example attributes of the data type MLAbstractPerfReport.

TABLE 5
Example attributes of MLAbstractPerfReport

| | Support | | | | |
|---|---|---|---|---|---|
| Attribute name | Qualifier | isReadable | isWritable | isInvariant | isNotifyable |
| mLAbsractPerfReportID | M | T | F | F | F |
| mLAppsID | M | T | F | F | F |
| mLAbstractPerfRequests | O | T | F | F | F |
| aggregatePerfIndex | CM | T | F | F | F |
| mlAbstractPerfIndexList | CM | T | F | F | F |

Table 6 shows example attribute definitions according to the example embodiments of the present disclosure.

TABLE 6
Attribute definitions

| Attribute Name | Documentation and Allowed Values | Properties |
|---|---|---|
| MLAppID | It indicates an identifier for a specific | type: String |
| | MLApp or MLApp. It may include the | multiplicity: * |
| | version identifiers of any such MLApp or | isOrdered: False |
| | MLApp | isUnique: True |
| | | defaultValue: None |
| | | isNullable: True |
| mLFunctionID | It indicates a managed function that initiates | type: String |
| | the request for MLPerformanceAbstraction | multiplicity: 1 |
| | | isOrdered: N/A |
| | | isUnique: N/A |
| | | defaultValue: None |
| | | isNullable: True |
| mlPerformanceIndexRange | It indicates the fixed range within which | type: list |
| | ML Performance metrics shall be mapped. | multiplicity: * |
| | Possible values: a tuple of (lowest value, | isOrdered: False |
| | highest value) | isUnique: True |
| | | defaultValue: None |
| | | isNullable: True |
| MLAbstractPerfReportID | It indicates an identifier for a specific | type: integer |
| | MLPerformanceAbstraction report | multiplicity: 1 |
| | | isOrdered: N/A |
| | | isUnique: N/A |
| | | defaultValue: None |
| | | isNullable: False |
| mlPerformanceMetrics | It indicates ML-related performance | type: list |
| | metrics that shall be evaluated by the | multiplicity: 1 |
| | MLPerformanceAbstraction for generating | isOrdered: N/A |
| | the abstract performance index. | isUnique: N/A |
| | Each entry is a tuple of | defaultValue: None |
| | (performanceMetric, value) | isNullable: False |
| mlAbstractPerfIndexList | Indicates the list achieved performance of | type: list |
| | the ML App on the set of performance | multiplicity: 1 |
| | metrics. Each entry is a tuple of | isOrdered: N/A |
| | (performanceMetric, mlAbstractPerfIndex), the | isUnique: N/A |
| | mlAbstractPerfIndex expressed as a | defaultValue: None |
| | number on fixed grade. For example, a | isNullable: False |
| | grade of 11 values (0 to 10) may be used | |
| | where the lowest value (0) indicates the | |
| | worst possible performance, and the largest | |
| | value (10) indicates the best possible | |
| | performance. | |
| aggregatePerfIndex | Indicates the aggregate abstract achieved | type: integer |
| | performance of the ML App on the full set | multiplicity: 1 |
| | of performance metrics. It is expressed as a | isOrdered: N/A |
| | number on fixed grade. For example, a | isUnique: N/A |
| | grade of 11 values (0 to 10) may be used | defaultValue: None |
| | where the lowest value (0) indicates the | isNullable: False |
| | worst possible performance, and the largest | |
| | value (10) indicates the best possible | |
| | performance. | |

### Example Methods

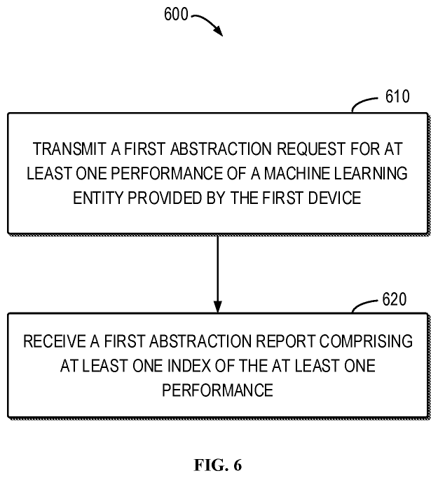

FIG. 6 shows a flowchart of an example method 600 implemented at a first device in accordance with some example embodiments of the present disclosure. For the purpose of discussion, the method 600 will be described from the perspective of the first device 110 in FIG. 1.

At block 610, the first device 110 transmits, to a second device 120, a first abstraction request for at least one performance of a machine learning entity provided by the first device. The machine learning entity is used for a third device 130.

At block 820, the first device 110 receives, from the second device 120, a first abstraction report comprising at least one index of the at least one performance, the at least one index being understandable by the third device 130.

In some example embodiments, the first abstraction request may comprise an identity of the machine learning entity and at least one metric value for the at least one performance.

In some example embodiments, the first abstraction request may be transmitted by the first device 110 performing a task of the machine learning entity.

In some example embodiments, the first device 110 may receive, from the third device 130, a second abstraction request comprises an indication of the machine learning entity and at least one metric for the at least one performance. The first device 110 may transmit, to the second device 120, the first abstraction request comprising the indication of the machine learning entity and at least one metric values of the at least one metric for the at least one performance.

In some example embodiments, the first device 110 may transmit, to the third device 130, a second abstraction report comprising the at least one index of the at least one performance.

In some example embodiments, the indication of the machine learning entity may comprise at least one of the following: a name of the machine learning entity, an identity of the machine learning entity, a domain name of the machine learning entity.

In some example embodiments, the first device 110 may receive, from the third device 130, a second abstraction request comprises an indication of the machine learning entity and at least one metric for the at least one performance. The first device 110 may transmit, to the third device 130, a second abstraction report comprising the at least one index of the at least one performance.

In some example embodiments, the at least one performance may comprises at least one of the following: a precision, a recall, a F1-score, an accuracy, mean absolute error, root mean squared error, trustworthiness, resource consumption, speed of the machine learning entity.

In some example embodiments, an index range for the at least one performance may be predetermined at the first device 110, the second device 120 and the third device 130.

In some example embodiments, the first device 110 may comprise a machine learning management service producer or a machine learning enabled function. The second device 120 may comprise a performance abstraction management service producer providing performance abstraction. The third device 130 may comprise a performance abstraction management service consumer.

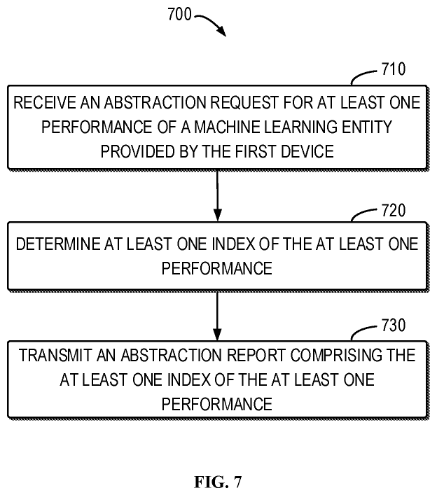

FIG. 7 shows a flowchart of an example method 700 implemented at a second device in accordance with some example embodiments of the present disclosure. For the purpose of discussion, the method 700 will be described from the perspective of the second device 120 in FIG. 1.

At 710, the second device 120 receives, from one of a first device 110 or a third device 130, an abstraction request for at least one performance of a machine learning entity provided by the first device. The machine learning entity is used for the third device 130.

At 720, the second device 120 determines at least one index of the at least one performance. The at least one index is understandable by the third device 130.

At 730, the second device 120 transmits, to a corresponding one of the first device 110 or the third device 130, an abstraction report comprising the at least one index of the at least one performance.

In some example embodiments, the second device 120 may receive, from the first device 110, a first abstraction request comprising an indication of the machine learning entity and at least one metric value for the at least one performance. The second device 120 may determine the at least one index corresponding to the at least one metric values.

In some example embodiments, the second device 120 may transmit, to the first device 110, a first abstraction report comprising the at least one index of the at least one performance.

In some example embodiments, the first abstraction request may be received from the first device performing a task of the machine learning entity.

In some example embodiments, the second device 120 may receive, from the third device 130, a third abstraction request comprising an indication of the machine learning entity and at least one metric for the at least one performance. The second device 120 may transmit, to the first device 110, a request for at least one metric value for the at least one performance. The second device 120 may receive, from the first device 110, a response comprising the at least one metric value for the at least one performance. Accordingly, the second device 120 may determine the at least one index corresponding to the at least one metric values.

In some example embodiments, the second device 120 may transmit, to the third device 130, a third abstraction report comprising the at least one index of the at least one performance.

In some example embodiments, the indication of the machine learning entity may comprise at least one of the following: a name of the machine learning entity, an identity of the machine learning entity, a domain name of the machine learning entity.

In some example embodiments, the at least one performance comprises at least one of the following: a precision, a recall, a F1-score, an accuracy, mean absolute error, root mean squared error, trustworthiness, resource consumption, speed of the machine learning entity.

In some example embodiments, the at least one index may be determined from an index range for the at least one performance predetermined at the first device 110, the second device 120 and the third device 130.

In some example embodiments, the second device 120 may publish the at least one index of the at least one performance to a portal shared by the first device 110 and the third device 130.

In some example embodiments, the first device 110 may comprise a machine learning management service producer or a machine learning enabled function. The second device 120 may comprise a performance abstraction management service producer providing performance abstraction. The third device 130 may comprise a performance abstraction management service consumer.

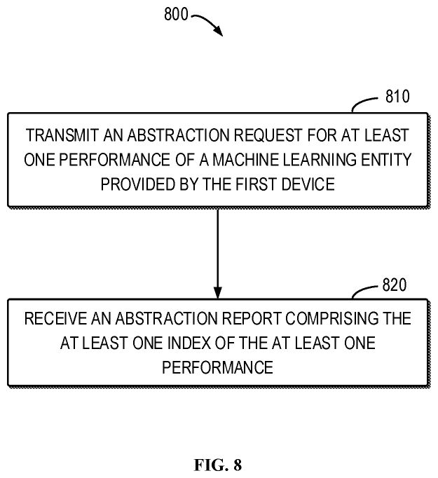

FIG. 8 shows a flowchart of an example method 800 implemented at a third device in accordance with some example embodiments of the present disclosure. For the purpose of discussion, the method 800 will be described from the perspective of the third device 130 in FIG. 1.

At block 810, the third device 130 transmits, to one of a first device 110 or a second device 120, an abstraction request for at least one performance of a machine learning entity provided by the first device, the machine learning entity used for the third device 130.

At block 820, the second device 120 receives, from a corresponding one of the first device 110 or the second device 120, an abstraction report comprising the at least one index of the at least one performance, the at least one index being understandable by the third device 130.

In some example embodiments, the third device 130 may transmit, to the first device 110, a second abstraction request comprising an indication of the machine learning entity and at least one metric for the at least one performance, the transmission of the second abstraction request causing a first abstraction request transmitted from the first device to the second device.

In some example embodiments, the third device 130 may receive, from the first device 110, a second abstraction report comprising the at least one index of the at least one performance.

In some example embodiments, the third device 130 may transmit, to the second device 120, a third abstraction request comprises an indication of the machine learning entity and at least one metric for the at least one performance. The transmission of the third abstract request may cause a request for at least one metric value for the at least one performance transmitted from the second device 120 to the first device 110.

In some example embodiments, the third device 130 may receive, from the second device 120, a second abstraction report comprising the at least one index of the at least one performance.

In some example embodiments, the indication of the machine learning entity comprises at least one of the following: a name of the machine learning entity, an identity of the machine learning entity, a domain name of the machine learning entity.

In some example embodiments, the at least one performance comprises at least one of the following: a precision, a recall, a F1-score, an accuracy, mean absolute error, root mean squared error, trustworthiness, resource consumption, speed of the machine learning entity.

In some example embodiments, an index range for the at least one performance may be predetermined at the first device 110, the second device 120 and the third device 130.

In some example embodiments, the first device 110 may comprise a machine learning management service producer or a machine learning enabled function. The second device 120 may comprise a performance abstraction management service producer providing performance abstraction. The third device 130 may comprises a performance abstraction management service consumer.

### Example Apparatus, Device and Medium

In some example embodiments, a first apparatus capable of performing any of the method 600 (for example, the first device 110 in FIG. 1) may comprise means for performing the respective operations of the method 600. The means may be implemented in any suitable form. For example, the means may be implemented in a circuitry or software module. The first apparatus may be implemented as or included in the first device 110 in FIG. 1.

In some example embodiments, the first apparatus comprises: means for transmitting, to a second apparatus, a first abstraction request for at least one performance of a machine learning entity provided by the first apparatus, the machine learning entity used for a third apparatus; and means for receiving, from the second apparatus, a first abstraction report comprising at least one index of the at least one performance, the at least one index being understandable by the third apparatus.

In some example embodiments, the first abstraction request comprises an identity of the machine learning entity and at least one metric value for the at least one performance.

In some example embodiments, the first abstraction request is transmitted by the first apparatus performing a task of the machine learning entity.

In some example embodiments, the means for transmitting the first abstraction request comprises means for receiving, from the third apparatus, a second abstraction request comprises an indication of the machine learning entity and at least one metric for the at least one performance; and means for transmitting, to the second apparatus, the first abstraction request comprising the indication of the machine learning entity and at least one metric values of the at least one metric for the at least one performance.

In some example embodiments, the first apparatus further comprises: means for transmitting the third apparatus, a second abstraction report comprising the at least one index of the at least one performance.

In some example embodiments, the indication of the machine learning entity comprises at least one of the following: a name of the machine learning entity, an identity of the machine learning entity, a domain name of the machine learning entity.

In some example embodiments, the first apparatus further comprises: means for receiving, from the third apparatus, a second abstraction request comprises an indication of the machine learning entity and at least one metric for the at least one performance; and means for transmitting, to the third apparatus, a second abstraction report comprising the at least one index of the at least one performance.

In some example embodiments, the at least one performance comprises at least one of the following: a precision, a recall, a F1-score, an accuracy, mean absolute error, root mean squared error, trustworthiness, resource consumption, speed of the machine learning entity.

In some example embodiments, an index range for the at least one performance is predetermined at the first apparatus, the second apparatus and the third apparatus.

In some example embodiments, the first apparatus comprises a machine learning management service producer or a machine learning enabled function, the second apparatus comprises a performance abstraction management service producer providing performance abstraction, and the third apparatus comprises a performance abstraction management service consumer.

In some example embodiments, a second apparatus capable of performing any of the method 700 (for example, the second device 120 in FIG. 1) may comprise means for performing the respective operations of the method 700. The means may be implemented in any suitable form. For example, the means may be implemented in a circuitry or software module. The second apparatus may be implemented as or included in the second device 120 in FIG. 1.

In some example embodiments, the second apparatus comprises: means for receiving, from one of a first apparatus or a third apparatus, an abstraction request for at least one performance of a machine learning entity provided by the first apparatus, the machine learning entity used for the third apparatus; means for determining at least one index of the at least one performance, the at least one index being understandable by the third apparatus; and means for transmitting, to a corresponding one of the first apparatus or the third apparatus, an abstraction report comprising the at least one index of the at least one performance.

In some example embodiments, the means for receiving the abstraction request comprises: means for receiving, from the first apparatus, a first abstraction request comprising an indication of the machine learning entity and at least one metric value for the at least one performance; and means for determining the at least one index corresponding to the at least one metric values.

In some example embodiments, the means for transmitting the abstraction report comprises: means for transmitting, to the first apparatus, a first abstraction report comprising the at least one index of the at least one performance.

In some example embodiments, the first abstraction request is received from the first apparatus performing a task of the machine learning entity.

In some example embodiments, the means for receiving the abstraction request comprises: means for receiving, from the third apparatus, a third abstraction request comprising an indication of the machine learning entity and at least one metric for the at least one performance; means for transmitting, to the first apparatus, a request for at least one metric value for the at least one performance; means for receiving, from the first apparatus, a response comprising the at least one metric value for the at least one performance; and means for determining the at least one index corresponding to the at least one metric values.

In some example embodiments, the means for transmitting the abstraction report comprises: means for transmitting, to the third apparatus, a third abstraction report comprising the at least one index of the at least one performance.

In some example embodiments, the indication of the machine learning entity comprises at least one of the following: a name of the machine learning entity, an identity of the machine learning entity, a domain name of the machine learning entity.

In some example embodiments, the at least one performance comprises at least one of the following: a precision, a recall, a F1-score, an accuracy, mean absolute error, root mean squared error, trustworthiness, resource consumption, speed of the machine learning entity.

In some example embodiments, the at least one index is determined from an index range for the at least one performance predetermined at the first apparatus, the second apparatus and the third apparatus.

In some example embodiments, the second apparatus further comprises: means for publishing the at least one index of the at least one performance to a portal shared by the first apparatus and the third apparatus.

In some example embodiments, the first apparatus comprises a machine learning management service producer or a machine learning enabled function, the second apparatus comprises a performance abstraction management service producer providing performance abstraction, and the third apparatus comprises a performance abstraction management service consumer.

In some example embodiments, a third apparatus capable of performing any of the method 800 (for example, the third device 130 in FIG. 1) may comprise means for performing the respective operations of the method 800. The means may be implemented in any suitable form. For example, the means may be implemented in a circuitry or software module. The second apparatus may be implemented as or included in the third device 130 in FIG. 1.

In some example embodiments, the third apparatus further comprises: means for transmitting, to one of a first apparatus or a second apparatus, an abstraction request for at least one performance of a machine learning entity provided by the first apparatus, the machine learning entity used for the third apparatus; and means for receiving, from a corresponding one of the first apparatus or the second apparatus, an abstraction report comprising the at least one index of the at least one performance, the at least one index being understandable by the third apparatus.

In some example embodiments, the means for transmitting the abstraction request comprises: means for transmitting, to the first apparatus, a second abstraction request comprising an indication of the machine learning entity and at least one metric for the at least one performance, the transmission of the second abstraction request causing a first abstraction request transmitted from the first apparatus to the second apparatus.

In some example embodiments, the means for receiving the abstraction report comprises: means for receiving, from the first apparatus, a second abstraction report comprising the at least one index of the at least one performance.

In some example embodiments, the means for transmitting the abstraction request comprises: means for transmitting, to the second apparatus, a third abstraction request comprises an indication of the machine learning entity and at least one metric for the at least one performance, the transmission of the third abstract request causing a request for at least one metric value for the at least one performance transmitted from the second apparatus to the first apparatus.

In some example embodiments, the means for receiving the abstraction report comprises: means for receiving, from the second apparatus, a second abstraction report comprising the at least one index of the at least one performance.

In some example embodiments, the indication of the machine learning entity comprises at least one of the following: a name of the machine learning entity, an identity of the machine learning entity, a domain name of the machine learning entity.

In some example embodiments, the at least one performance comprises at least one of the following: a precision, a recall, a F1-score, an accuracy, mean absolute error, root mean squared error, trustworthiness, resource consumption, speed of the machine learning entity.

In some example embodiments, an index range for the at least one performance is predetermined at the first apparatus, the second apparatus and the third apparatus.

In some example embodiments, the first apparatus comprises a machine learning management service producer or a machine learning enabled function, the second apparatus comprises a performance abstraction management service producer providing performance abstraction, and the third apparatus comprises a performance abstraction management service consumer.

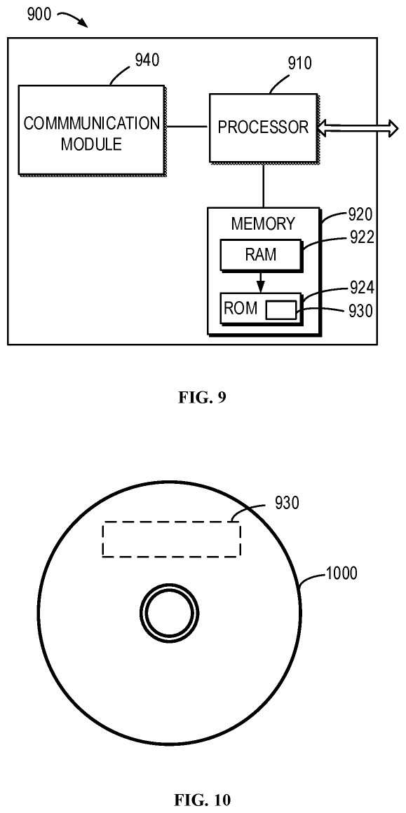

FIG. 9 is a simplified block diagram of a device 900 that is suitable for implementing example embodiments of the present disclosure. The device 900 may be provided to implement an electronic device, for example, the first device 110, the second device 120 or the third device 130 as shown in FIG. 1. As shown, the device 900 includes one or more processors 910, one or more memories 920 coupled to the processor 910, and one or more communication modules 940 coupled to the processor 910.

The communication module 940 is for bidirectional communications. The communication module 940 has one or more communication interfaces to facilitate communication with one or more other modules or devices. The communication interfaces may represent any interface that is necessary for communication with other network elements. In some example embodiments, the communication module 940 may include at least one antenna.

The processor 910 may be of any type suitable to the local technical network and may include one or more of the following: general purpose computers, special purpose computers, microprocessors, digital signal processors (DSPs) and processors based on multicore processor architecture, as non-limiting examples. The device 900 may have multiple processors, such as an application specific integrated circuit chip that is slaved in time to a clock which synchronizes the main processor.

The memory 920 may include one or more non-volatile memories and one or more volatile memories. Examples of the non-volatile memories include, but are not limited to, a Read Only Memory (ROM) 924, an electrically programmable read only memory (EPROM), a flash memory, a hard disk, a compact disc (CD), a digital video disk (DVD), an optical disk, a laser disk, and other magnetic storage and/or optical storage. Examples of the volatile memories include, but are not limited to, a random access memory (RAM) 922 and other volatile memories that will not last in the power-down duration.

A computer program 930 includes computer executable instructions that are executed by the associated processor 910. The instructions of the program 930 may include instructions for performing operations/acts of some example embodiments of the present disclosure. The program 930 may be stored in the memory, e.g., the ROM 924. The processor 910 may perform any suitable actions and processing by loading the program 930 into the RAM 922.

The example embodiments of the present disclosure may be implemented by means of the program 930 so that the device 900 may perform any process of the disclosure as discussed with reference to FIG. 2 to FIG. 8. The example embodiments of the present disclosure may also be implemented by hardware or by a combination of software and hardware.

In some example embodiments, the program 930 may be tangibly contained in a computer readable medium which may be included in the device 900 (such as in the memory 920) or other storage devices that are accessible by the device 900. The device 1000 may load the program 930 from the computer readable medium to the RAM 922 for execution. In some example embodiments, the computer readable medium may include any types of non-transitory storage medium, such as ROM, EPROM, a flash memory, a hard disk, CD, DVD, and the like. The term “non-transitory,” as used herein, is a limitation of the medium itself (i.e., tangible, not a signal) as opposed to a limitation on data storage persistency (e.g., RAM vs. ROM).

FIG. 10 shows an example of the computer readable medium 1000 which may be in form of CD, DVD or other optical storage disk. The computer readable medium 1000 has the program 930 stored thereon.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representations, it is to be understood that the block, apparatus, system, technique or method described herein may be implemented in, as non-limiting examples, hardware, software, firmware, special purpose circuits or logic, general purpose hardware or controller or other computing devices, or some combination thereof.

Some example embodiments of the present disclosure also provides at least one computer program product tangibly stored on a computer readable medium, such as a non-transitory computer readable medium. The computer program product includes computer-executable instructions, such as those included in program modules, being executed in a device on a target physical or virtual processor, to carry out any of the methods as described above. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. The program code may be provided to a processor or controller of a general purpose computer, special purpose computer, or other programmable data processing apparatus, such that the program code, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program code or related data may be carried by any suitable carrier to enable the device, apparatus or processor to perform various processes and operations as described above. Examples of the carrier include a signal, computer readable medium, and the like.

The computer readable medium may be a computer readable signal medium or a computer readable storage medium. A computer readable medium may include but not limited to an electronic, magnetic, optical, electromagnetic, infrared, or semiconductor system, apparatus, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Unless explicitly stated, certain features that are described in the context of separate embodiments may also be implemented in combination in a single embodiment. Conversely, unless explicitly stated, various features that are described in the context of a single embodiment may also be implemented in a plurality of embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

1-37. (canceled)

38. A first device, comprising:
at least one processor; and
at least one memory storing instructions that, when executed by the at least one processor, cause the first device at least to:
transmit, to a second device, a first abstraction request for at least one performance of a machine learning entity provided by the first device, the machine learning entity used for a third device; and
receive, from the second device, a first abstraction report comprising at least one index of the at least one performance, the at least one index being understandable by the third device.

39. The first device of claim 38, wherein the first abstraction request comprises an identity of the machine learning entity and at least one metric value for the at least one performance.

40. The first device of claim 38, wherein the first abstraction request is transmitted by the first device performing a task of the machine learning entity.

41. The first device of claim 38, wherein the at least one memory storing instructions that, when executed by the at least one processor, cause the first device to transmit the first abstraction request by:
receiving, from the third device, a second abstraction request comprises an indication of the machine learning entity and at least one metric for the at least one performance; and
transmitting, to the second device, the first abstraction request comprising the indication of the machine learning entity and at least one metric values of the at least one metric for the at least one performance.

42. The first device of claim 41, wherein the at least one memory storing instructions that, when executed by the at least one processor, further cause the first device to:
transmit, to the third device, a second abstraction report comprising the at least one index of the at least one performance.

43. The first device of claim 41, wherein the indication of the machine learning entity comprises at least one of the following:
a name of the machine learning entity,
an identity of the machine learning entity,
a domain name of the machine learning entity.

44. The first device of claim 38, wherein the at least one memory storing instructions that, when executed by the at least one processor, further cause the first device to:
receive, from the third device, a second abstraction request comprises an indication of the machine learning entity and at least one metric for the at least one performance; and
transmit, to the third device, a second abstraction report comprising the at least one index of the at least one performance.

45. The first device of claim 38, wherein the at least one performance comprises at least one of the following:
a precision, a recall, a F1-score, an accuracy, mean absolute error, root mean squared error, trustworthiness, resource consumption, speed of the machine learning entity.

46. The first device of claim 38, wherein an index range for the at least one performance is predetermined at the first device, the second device and the third device.

47. The first device of claim 38, wherein the first device comprises a machine learning management service producer or a machine learning enabled function, the second device comprises a performance abstraction management service producer providing performance abstraction, and the third device comprises a performance abstraction management service consumer.

48. A second device, comprising:
at least one processor; and
at least one memory storing instructions that, when executed by the at least one processor, cause the second device at least to:
receive, from one of a first device or a third device, an abstraction request for at least one performance of a machine learning entity provided by the first device, the machine learning entity used for the third device;
determine at least one index of the at least one performance, the at least one index being understandable by the third device; and
transmit, to a corresponding one of the first device or the third device, an abstraction report comprising the at least one index of the at least one performance.

49. The second device of claim 48, wherein the at least one memory storing instructions that, when executed by the at least one processor, cause the second device to receive the abstraction request by:
receiving, from the first device, a first abstraction request comprising an indication of the machine learning entity and at least one metric value for the at least one performance; and
determining the at least one index corresponding to the at least one metric values.

50. The second device of claim 49, wherein the at least one memory storing instructions that, when executed by the at least one processor, cause the second device to transmit the abstraction report by:
transmitting, to the first device, a first abstraction report comprising the at least one index of the at least one performance.

51. The second device of claim 49, wherein the first abstraction request is received from the first device performing a task of the machine learning entity.

52. The second device of claim 48, wherein the at least one memory storing instructions that, when executed by the at least one processor, cause the second device to receive the abstraction request by:
receiving, from the third device, a third abstraction request comprising an indication of the machine learning entity and at least one metric for the at least one performance;
transmitting, to the first device, a request for at least one metric value for the at least one performance;
receiving, from the first device, a response comprising the at least one metric value for the at least one performance; and
determining the at least one index corresponding to the at least one metric values.

53. The second device of claim 52, wherein the at least one memory storing instructions that, when executed by the at least one processor, cause the second device to transmit the abstraction report by:
transmitting, to the third device, a third abstraction report comprising the at least one index of the at least one performance.

54. A third device, comprising:
at least one processor; and
at least one memory storing instructions that, when executed by the at least one processor, cause the third device at least to:
transmit, to one of a first device or a second device, an abstraction request for at least one performance of a machine learning entity provided by the first device, the machine learning entity used for the third device; and
receive, from a corresponding one of the first device or the second device, an abstraction report comprising the at least one index of the at least one performance, the at least one index being understandable by the third device.

55. The third device of claim 54, wherein the at least one memory storing instructions that, when executed by the at least one processor, cause the third device to transmit the abstraction request by:
transmitting, to the first device, a second abstraction request comprising an indication of the machine learning entity and at least one metric for the at least one performance, the transmission of the second abstraction request causing a first abstraction request transmitted from the first device to the second device.

56. The third device of claim 55, wherein the at least one memory storing instructions that, when executed by the at least one processor, cause the third device to receive the abstraction report by:
receiving, from the first device, a second abstraction report comprising the at least one index of the at least one performance.

57. The third device of claim 54, wherein the at least one memory storing instructions that, when executed by the at least one processor, cause the third device to transmit the abstraction request by:
transmitting, to the second device, a third abstraction request comprises an indication of the machine learning entity and at least one metric for the at least one performance, the transmission of the third abstract request causing a request for at least one metric value for the at least one performance transmitted from the second device to the first device.
